(19) United States
(12) Patent Application Publication
(10) Pub. No.: US 2026/0211375 A1
(43) Pub. Date: Jul. 23, 2026

(54) SMART ANALOG WATCH

(71) Applicant: WRIST WATCHERS LLC, Clayton, NC (US)

(72) Inventor: Faheem Allibhai, Clayton, NC (US)

(21) Appl. No.: 19/028,093

(22) Filed: Jan. 17, 2025

(51) Int. Cl. G04B 47/00; G04G 21/04

(52) U.S. Cl. CPC G04B 47/00; G04G 21/04

(57) ABSTRACT

Luxury analog watches are appreciated for their looks. By adding Smartwatch features to the inner and/or outer back of the analogue watch, the front and side look remain unobstructed or changed.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an analog watch that has been modified and designed to provide smart watch features without interfering with the esthetics of the analog watch. In particular, smart watch features are hidden from the viewable part of the watch, i.e. the face and sides of the watch.

### Description of Related Art

The area of luxury watches is filled with numerous very expensive watches. If a person has one of these watches, they bought it for the looks of the analog watch and such a person does not want the looks of the watch altered in the viewable parts of the watch, i.e. the face and sides.

The art shows that the idea of adding smart watch features to an analog watch is done by placement of the additional features where they can be seen by the user of the watch and by others looking at the watch. But in the luxury market that is not acceptable to change to the looks of a luxury watch like a Rolex, for example. Smart watch features are very popular but not in the interest of luxury watch owners if it compromises looks in any way.

### BRIEF SUMMARY OF THE INVENTION

The present invention relates to an analog watch comprising:

a) one or more smart watch features wherein the features are positioned on the outer back or inner back of the analog watch and not on the front or sides; and

b) wherein the smart watch features can communicate with a smart phone in order to view the features.

By positioning smart watch features in the back of the analog watch and transmitting the measurements to a corresponding smart phone an analog watch can comprise smart watch features without changing the viewable parts of the analog watch.

### BRIEF DESCRIPTION OF THE DRAWINGS

FIG. 1 is a frontal view of the analog watch of the invention.

FIG. 2a is a back view of the analog watch of the invention.

FIG. 2b is a side view of the back of the analog watch showing the two positions the smart features can be placed.

FIG. 3 shows the smart watch features transmitted to a smart phone for viewing.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms "a" or "an", as used herein, are defined as one or as more than one. The term "plurality", as used herein, is defined as two or as more than two. The term "another", as used herein, is defined as at least a second or more. The terms "including" and/or "having", as used herein, are defined as comprising (i.e., open language). The term "coupled", as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to "one embodiment", "certain embodiments", “an embodiment", or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term "or", as used herein, is to be interpreted as an inclusive or meaning any one or any combination. Therefore, "A, B, or C" means any of the following: "A; B; C; A and B; A and C; B and C; A, B, and C". An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “analog watch” refers to a watch that displays the time using hands that mechanically or via a quartz movement or the like move around a dial, rather than digitally created hands, time or numbers. This especially refers to luxury analog watches which are prized for their non-digital appearance on the face and sides of the watch.

As used herein, the term “one or more smart watch features” refers to the features which are available on a smart watch and not on a regular analog watch which are added to an analog watch as described herein. These include but are not limited to step tracking, heart rate, sleep, cycling, rowing, stair stepper, running, swimming and activity monitoring. GPS maps/ tracking, Geo Fencing, emergency beacon, ECG/AFIB monitoring, low cardio notification, blood oxygen level monitoring, fall detection, wrist temperature, calorie counter, stress level management, notification vibration alert, wallet, movement disabling mechanism, security feature, location tracking, ability to disable the features, movement performance indicator, and the like.

As used herein, the term “positioned on the outer back or inner back” refers to positioning any smart watch features in a position that doesn’t obscure the viewing of the face or sides of the analog watch. In other words, the back of the analog watch. These features can be added to the outside back of the analog watch of contained inside the back of the watch. The device sends any smart watch feature to a smart phone for viewing rather than viewing those features on the watch itself.

As used herein, the term “communicate with a smart phone” refers to the added smart watch features being able to connect to a smart phone, e.g. by Bluetooth, so that the user of the watch can view the smart watch features.

### DRAWINGS

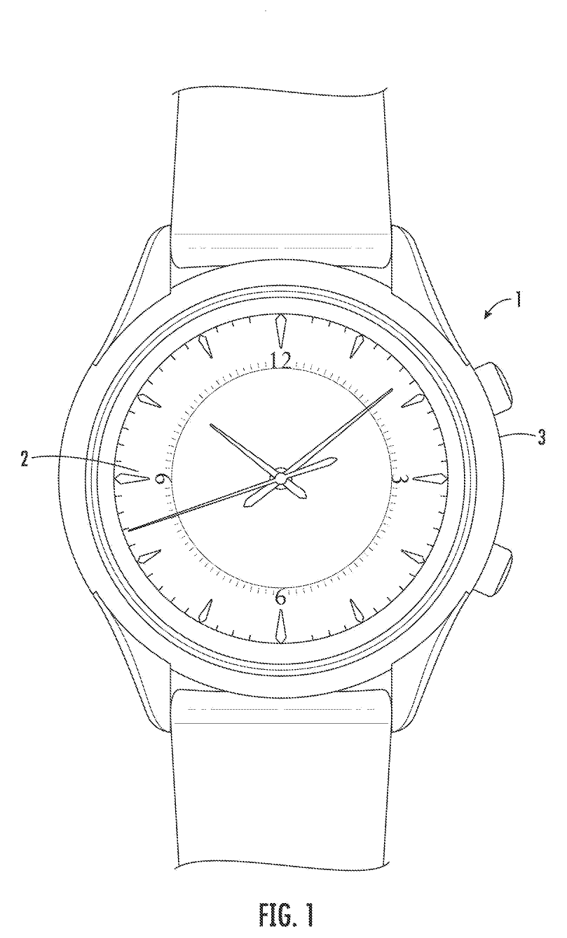

Now referring to the drawings, FIG. 1 is a view of the front of a luxury analog watch 1. The face 2 is shown as would normally be seen without anything to obscure the view of the face 2 or the sides 3.

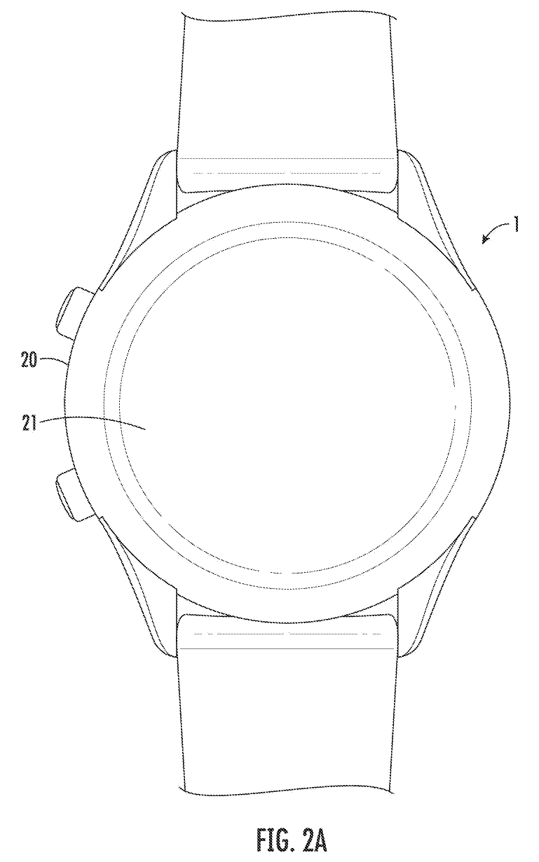

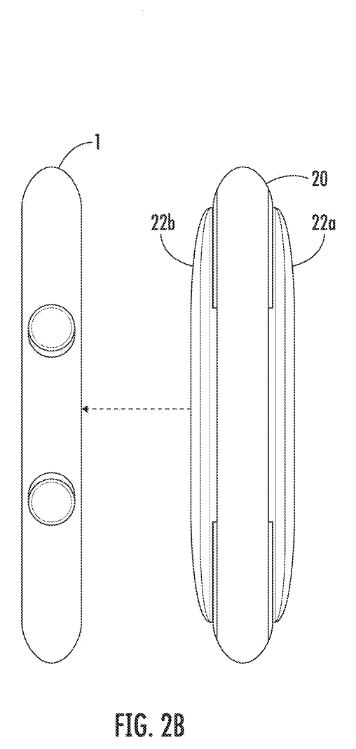

FIG. 2a is a back view of the watch 1 back side with a smart watch feature 21 attached thereto. FIG. 2b depicts a side view of the watch back 20 showing the smart feature outside the watch 22a or inside the watch back 22b.

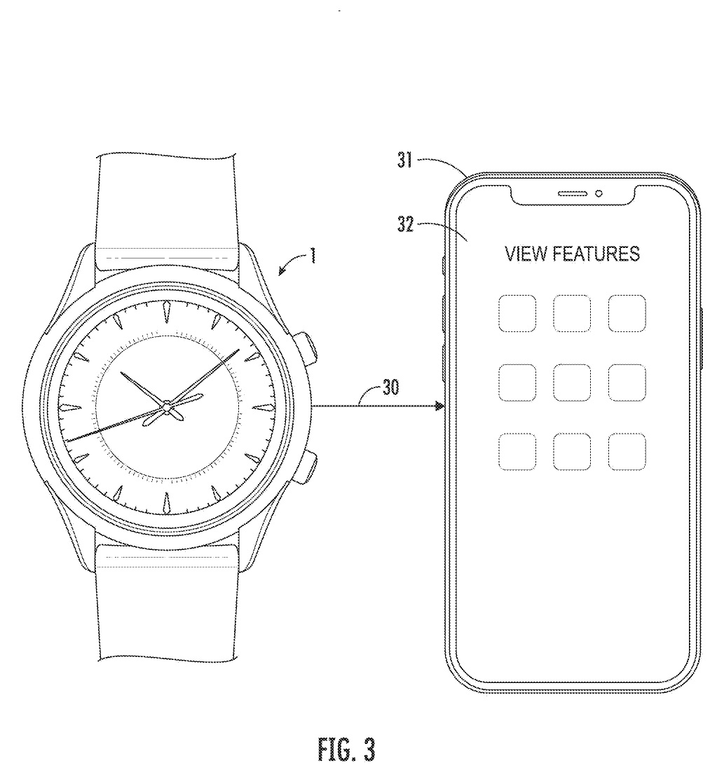

FIG. 3 shows a Bluetooth connection 30 between the analog watch 1 and a smart phone 31 showing smart phone features 32.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. An analog watch comprising:
a) one or more smart watch features wherein the features are positioned on the outer back or inner back of the analog watch and not on the front or sides; and
b) wherein the smart watch features can communicate with a smart phone in order to view the features.

2. An analog watch according to claim 1 wherein the smart watch feature is a security feature.

3. An analog watch according to claim 1 wherein the smart watch feature is an ability to disable one or more of the smart watch features.

4. An analog watch according to claim 1 wherein the smart watch feature is a location tracking device.
